(19) United States
(12) Patent Application Publication
(10) Pub. No.: US 2018/0374117 A1
(43) Pub. Date: Dec. 27, 2018

(54) SELECTING AND RANKING ADVERTISEMENTS FROM ONE OR MORE DATABASES USING ADVERTISER BUDGET INFORMATION

(71) Applicant: Dex Media, Inc., D/FW Airport, TX (US)

(72) Inventors: Wendell Hicken, La Verne, CA (US); Joshua Melick, Oakland, CA (US)

(21) Appl. No.: 16/115,320

(22) Filed: Aug. 28, 2018

Related U.S. Application Data
(63) Continuation of application No. 12/965,773, filed on Dec. 10, 2010, now abandoned.

(51) Int. Cl. G06Q 30/02

(52) U.S. Cl. CPC G06Q 30/0249

(57) ABSTRACT

An advertising system logs performance data regarding user interactions with advertisements from a plurality of advertisers. The advertising system uses the performance data to calculate various performance metrics, which are, in turn, used to determine budget weighting values for each of the plurality of advertisers. The advertising system retrieves candidate advertisements from one to more databases based on the user's context (e.g., a user search request). The advertising system selects particular advertisements and/or sorts the advertisements using the budget weighting values, and then sends them to the user (e.g., for display on the user's terminal or device).

### CROSS-REFERENCE TO RELATED APPLICATIONS

The present invention is a continuation of and claims the benefit and priority to U.S. patent application Ser. No. 12/965,773 filed Dec. 10, 2010, and entitled Selecting And Ranking Advertisements From One Or More Databases Using Advertiser Budget Information, the contents of which are incorporated herein by reference in its entirety.

### DESCRIPTION

### Field of the Invention

At least some embodiments disclosed herein relate to advertising systems in general, and more particularly, but not limited to, selecting one or more advertisements from one or more databases for sending at least one advertisement to a publisher.

### Background

The Internet, cellular communication systems, television, newspaper, etc., provide diverse communication media channels through which people may receive information and/or communicate with one another.

For example, people may use a website to chronologically publish personal thoughts and web links. Such a web site may be referred to as a blog. Another website may be used to search for information (e.g., Google's search website). Yet other websites may be used for interacting with online social networks (e.g., Facebook's social website).

When a user interacts with one of the foregoing websites, or others, using a user terminal or user device (e.g., a laptop computer or an iPhone telecommunication device), advertisements (sometimes referred to herein as simply “ads”) are often presented for display to the user. These ads are sometimes presented in response to a user request (e.g., a search request), and in other cases are presented even without any particular request or action by the user (e.g., an ad presented when an webpage is first loaded onto a user's device).

Advertisements may also be presented to users (e.g., potential customers) that communicate using other forms of media. In addition to websites, users may receive information and communicate, for example, via cellular phones or other mobile devices, television or video devices, and even through traditional print media (e.g., where the user is a reader of the print media, and then later takes an action online using information found in the print media).

Publishers of the various foregoing forms of media often make decisions to select particular ads for particular users or readers. A publisher usually selects ads that will be most effective for attracting business from the user to the service or product provider that has sponsored an advertisement accompanying or presented during the user's interaction on or with the media.

### BRIEF DESCRIPTION OF THE DRAWINGS

The embodiments are illustrated by way of example and not limitation in the figures of the accompanying drawings in which like references indicate similar elements.

FIG. 1 shows a system for selecting an advertisement using an advertising platform and presenting the advertisement to a user according to one embodiment.

FIG. 2 shows the structure of an advertising platform according to one embodiment.

FIG. 3 shows an example of a web page having advertisements according to one embodiment.

FIG. 4 shows the sorting of advertisements prior to sending to publishers according to one embodiment.

FIG. 5 shows an example of weighted advertisement rotation according to one embodiment.

FIG. 6 shows a system for communications between user terminals, publishers, and the advertising platform of FIG. 1 according to one embodiment.

FIG. 7 shows a block diagram of a data processing system which can be used in various embodiments.

FIG. 8 shows a block diagram of a user terminal or device according to one embodiment.

FIG. 9 shows a method to select an advertisement from at least one database using the advertising system of FIG. 1 according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

As used herein a “pay-per-call advertisement” is an advertisement for which some form of compensation is provided on a per call basis (e.g., a payment by a service provider for each call made to the service provider in response to an online advertisement seen by a user on a user terminal). For example, the compensation may be in the form of a cash payment or credit (e.g., made online via a computer system). Examples of pay-per-call advertisements and systems therefor are described in U.S. Patent Application Publication No. 2007/0162334, published Jul. 12, 2007 (titled “SYSTEMS AND METHODS TO CONVERT A CALL GENERATED FROM AN ADVERTISEMENT” by Altberg et al.)

Systems and methods to select one or more advertisements from one or more databases for sending at least one advertisement (e.g., as a set of advertisement units) to a publisher (e.g., through an application programming interface accessed by a computer server of the publisher) are described below. In one embodiment, a method implemented in a data processing system includes: determining a user context; retrieving, via the data processing system, candidate advertisements from at least one advertisement database to create an advertisement candidate pool, the retrieving based on the user context; selecting, via the data processing system, a set of advertisements from the advertisement candidate pool; and sending the set of advertisements.

The determining the user context may include identifying a user as belonging to a demographic category (e.g., a young mother), and the retrieving may be based on the demographic category (e.g., selecting advertisements for baby products or services). In one example, the set of advertisements are provided in reply to an ad request (also referred to sometimes as a specific ad call). The ad request may include a search term, location, and a number of ads requested. The location may be the user location, or may be another location provided by the publisher for other business reasons or goals.

In one embodiment, the determining the user context comprises receiving a first advertisement request comprising user search data corresponding to a search request of a user, where the user search data includes a search term. The retrieving is based on the search term, and the sending of the set of advertisements is in reply to the first advertisement request. In one embodiment, the user search data further includes a search location, and the retrieving is further based on the search location.

In one embodiment, the method further comprises logging performance data regarding user interactions with the set of advertisements, and adding the performance data to an historical performance database. The retrieving is performed further based on the data in the historical performance database (e.g., to improve advertisement effectiveness based on feedback from actual user purchases or contacts with advertisers). The method may include providing an annotation to each advertisement in the set of advertisements for use in tracking each respective advertisement, and receiving tracking data corresponding to each respective advertisement.

In one embodiment, the selecting of the set of advertisements comprises scoring advertisements in the advertisement candidate pool according to a ranking function. In one embodiment, the selecting the set of advertisements comprises selecting the set of advertisements using weighted advertisement rotation. In one embodiment, the selecting the set of advertisements comprises sorting advertisements in the advertisement candidate pool into at least a first bucket and a second bucket, and the selecting further comprises associating the first bucket with a higher advertisement selection priority than the second bucket.

In one embodiment, the at least one advertisement database comprises a first database and a second database, the first database storing subscription advertisements and the second database storing pay-per-call advertisements. The first advertisement request may be a request for a subscription advertisement from a first publisher. The method may further comprise receiving a second advertisement request for a pay-per-call advertisement from a second publisher, wherein the first and second requests are received using a common application programming interface (API) supported by the data processing system. This is in contrast to prior systems that use multiple APIs, one for each type of advertisement desired by a publisher.

In one embodiment, the sending the set of advertisements comprises sending the set of advertisements to a publisher, and the method further comprises eliminating advertisement candidates from consideration for the advertisement candidate pool that are not in compliance with business rules provided by the publisher prior to the retrieving. For example, a particular publisher may require that no adult product advertisements, or advertisements from particular competitors, be sent to the publisher.

In one embodiment, the method may further comprise receiving, via the data processing system, advertisements from an advertiser, and storing the advertisements from the advertiser in the at least one database. The first advertisement request is received through an application programming interface, and the advertisements from the advertiser are received, via a data processing system (e.g., a web server) of the publisher, through the application programming interface.

In another system embodiment, a data processing system includes memory (e.g., hard drives or flash memory) storing at least one advertisement database (e.g., two or more databases, each storing a particular format or type of advertisement record). The data processing system includes at least one processor coupled to access the memory (e.g. via local addressing, a local area network, or via a link over the Internet). The at least one processor is configured to determine a user context; retrieve candidate advertisements from the at least one advertisement database to in order to create an advertisement candidate pool, the retrieving based on the user context; select a set of advertisements from the advertisement candidate pool; and send the set of advertisements.

The disclosure below includes various methods and apparatuses which perform these methods, including data processing systems which perform these methods, and computer readable media containing instructions which when executed on data processing systems cause the systems to perform these methods. Other features will be apparent from the accompanying drawings and from the detailed description which follows.

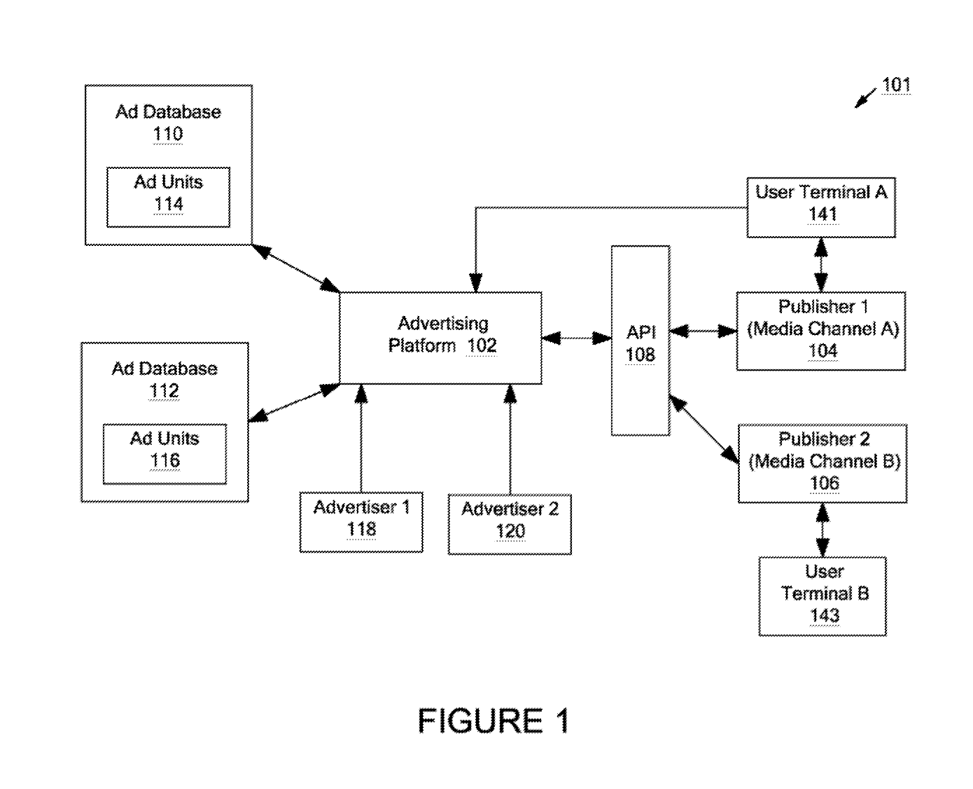

FIG. 1 shows a system 101 for selecting one or more advertisements using an advertising platform 102 and presenting the advertisement(s) to a user (e.g., via a social media publisher's website) according to one embodiment. Publishers 104, 106 each may access advertising platform 102 via an application programming interface (API) 108. Publishers 104, 106 may send requests for advertisements to platform 102. These requests may relate in this embodiment to user requests by users operating user terminals 141, 143, in which one of the users makes a search request to a server of publisher 104 or 106. One example of a user request is a search request by a user seeking information about a particular topic (e.g., the user enters a text search term into an input device of a user terminal, which search term is sent by the publisher to advertising platform 102).

In response to the ad request sent to platform 102, one or more databases 110, 116 are queried in order to retrieve ads that may be suitable for responding to the ad request. Each database 110, 116 may store ad units 114, 116. Alternatively, only a portion of an ad unit may be stored in database 110, 116, and the ad units 114, 116 may be finally assembled by platform 102 just before sending to publishers 104, 106. In one example, database 110 stores pay-per-call advertisements, and database 112 stores subscription advertisements.

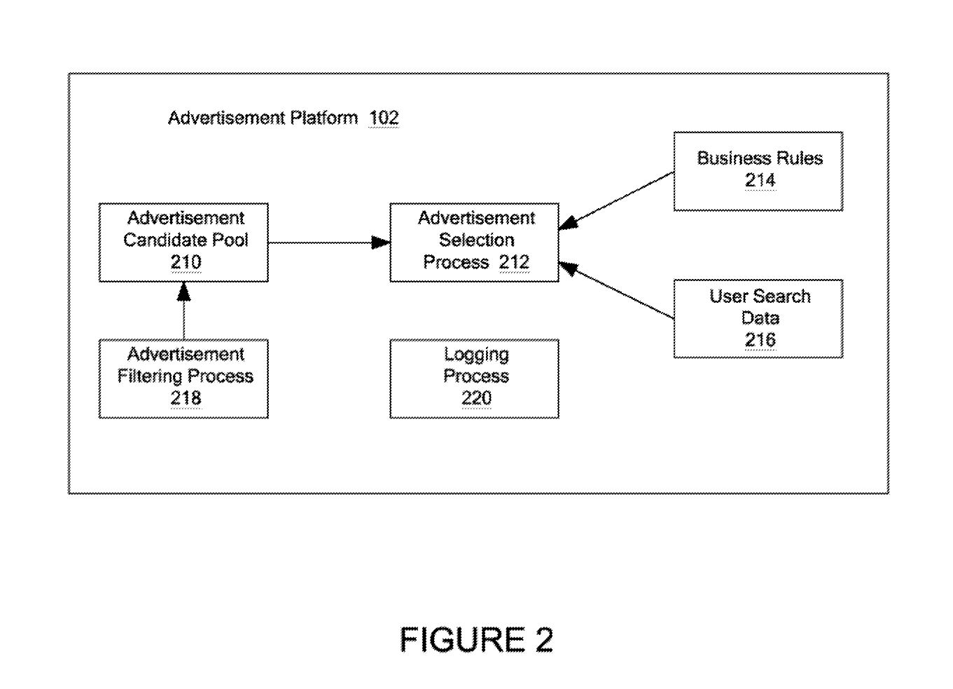

In one embodiment, database 116 stores a list of ads for each category/geographic combination associated with ad requests. This database provides, for example, candidate subscription ads for the advertising candidate pool 210 (see FIG. 2) discussed in more detail below. The user search data received from a publisher in an ad request includes a search location of a user on a user terminal. These ads are retrieved from the database at least in part based on this search location. The ad request also further includes the number of ads desired by the publisher.

The advertisements stored in databases 110, 116 may be provided from advertisers 118, 120. Advertisers 118, 120 may access platform 102 directly (e.g., via an API), or publishers 104, 106 may accept desired ads from advertisers 118, 120, and then publishers 104, 106 may provide the ads to platform 102 on behalf of advertisers 118, 120. Ads may also be provided from other sources.

In reply to the ad request, selected advertisements (e.g., in the form of ad units 114, 116) are sent to the requesting publisher 104 or 106. The selected ads are assembled by publishers 104, 106 into, for example, a web page that will be provided to a user in response to a user search request.

In general, publishers 104, 106 may maintain media channels of many various types including websites selling products or services, or social network websites, mobile media, cable and satellite television, video distribution, and print (e.g., newspapers and magazines). Advertising platform 102 may select advertisements from databases 114, 116 that are most appropriate for the media type of a publisher.

The advertisements sent to a publisher may correspond to various types of ad products including, for example, pay-per-call ads, presence ads, cost per click, or cost per impression. In one embodiment, advertising platform 102 is able to serve ad products (e.g., display ads, Internet Yellow Pages subscription ads, pay-per-call ads, cost-per-click/impression products) in different types of medium (e.g., print, web, mobile, video, television, and social) across multiple platforms (e.g., vendors, publishers, YP.com, and pay-per-call ads).

FIG. 2 shows the structure of advertising platform 102 according to specific one embodiment. Ads retrieved from databases 110 and 112 are assembled into an initial candidate pool 210. These are ads that are expected to be eligible for use with the ad request from publisher 104, 106.

An advertisement filtering process 218 runs on platform 102, and may use logic stored on platform 102 to narrow or reduce the size of the initial candidate pool. For example, filtering process 218 may narrow the pool based on particular configuration requests or characteristics of a given publisher. The narrowed ad pool thereby provides a set of ad listings that will be the final candidate pool from which ads are selected for sending to a requesting publisher 104, 106.

An advertisement selection process 212 runs on platform 102 and is applied to the final candidate pool that was obtained from the filtering process 218 above. In one embodiment, selection process 212 sorts and rotates candidate ads in candidate pool 210 with varying algorithms. This sorting, rotation, and particular algorithms may be configured for each particular publisher that interacts with platform 102.

Selection process 212 may use user search data 216, which is obtained from a publisher based on a search request from a user, to customize the particular ads that will be sent to a publisher. Also, business rules 214 may be used by selection process 212 in order to determine an ordering or priority with which ads will be sent from candidate pool 210 to a publisher. These business rules 214 may be provided by a publisher, for example, when configuring an account for the publisher with advertising platform 102, and also may be periodically updated by the publisher. Business rules 214 may place restrictions on the types or categories of ads that may be sent to a publisher in response to ad requests.

In one embodiment, advertisement selection process 212 chooses which, if any, of the available ads in candidate pool 210 should be shown for a given ad request. The considerations may include relevance (e.g., what is the applicable user looking for or interested in), as well as business rules 214 (e.g., rules related to the amount paid by a certain advertiser for the showing of its ads).

In this embodiment, when a large ad pool 210 is present, the pool 210 is narrowed down to minimize the amount of processing required by platform 210. In some embodiments, to all of the candidate ads are scored according to some ranking function, the list of all ads is sorted by that score, and then ads are selected from the top of this list as needed to satisfy an ad request. In some embodiments, further details may be used to narrow the list of ads, including eliminating ads that have already been shown to the specific user associated with the ad request.

An example of a scoring algorithm is one based on the cost that the advertiser is willing to pay for advertisements. The advertisers that pay the highest amount will have their ads appear most often. For a cost-per-impression (CPM) ad product, this is readily implemented. For a performance product (e.g., a pay-per-click advertising model, etc.), the business value depends on the likelihood that the user will click on the ad, multiplied by the revenue value of the click. In such a scenario, identifying ads that the user is most likely to click may be a key part of the scoring function. As platform 102 is better able to predict click-through rates, the more readily platform 102 can optimize ad impressions to increase revenue.

A logging process 220 may also run on platform 102. Performance data may be received and logged that indicates and records (in historical data records for future reference) the manner in which a user interacts with the advertisements that were sent to the publisher (and that are ultimately viewed by the user). This data may be added to an historical performance database stored at or accessible by platform 102. The retrieving of ads from databases 110, 112 may further be based on the data in the historical performance database. An annotation may be provided on each advertisement in the set of advertisements sent to the publisher for use in tracking each advertisement. The tracking data corresponding to each advertisement may be received directly by advertising platform 102 or via data from a publisher.

As examples of tracking and logging, tracking data may be provided to platform 102 in call-backs from a publisher's server (e.g., including information about which ads the publisher decided to show to users), or in call-backs from an end user's Internet browser (e.g., when a tracking pixel is rendered on a display of the user terminal, or when the user clicks on a link having a click wrapper, the user's request is routed through a server of platform 102 before being forwarded to its final destination so that platform 102 is able to count and log the click).

For pay-per-call ads, calls may be logged in to a call center in communication with platform 102. Based on the phone number that was dialed by a user, platform 102 is able to track the call back to a publisher and advertiser. Historical tracking data may be used, for example, to determine user preferences such as that people don't like certain ads (maybe for unknown reasons). Future ad delivery and distribution curves may be adjusted based on this feedback.

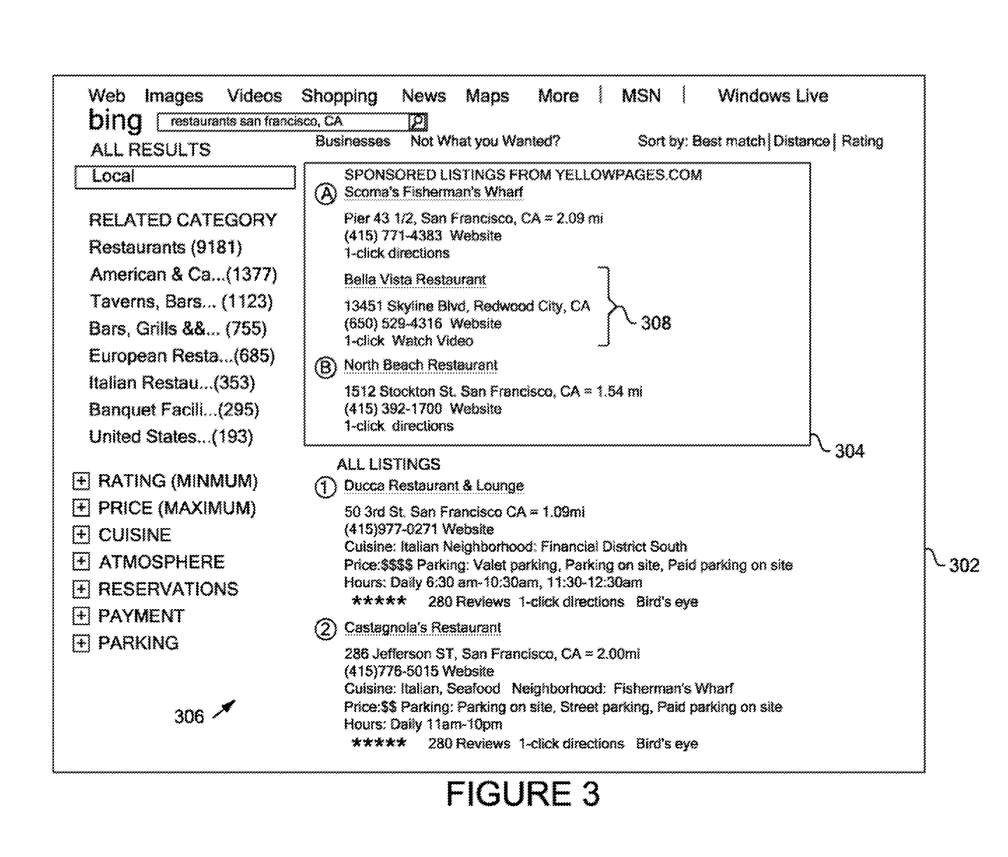

FIG. 3 shows an example of a web page 302 having advertisements displayed to a user on a user terminal according to one embodiment. An advertising area 304 presents a listing of the set of advertisements sent from platform 102 to publisher 104, 106. Advertising area 304 includes a number of ad units 308. These correspond to, but are not necessarily identical to, ad units 114, 116 retrieved by, or finally assembled at, advertising platform 102. A set of listings 306 are non-sponsored (e.g., free) search results presented in response to a search request of a user viewing web page 302 on a user terminal 141.

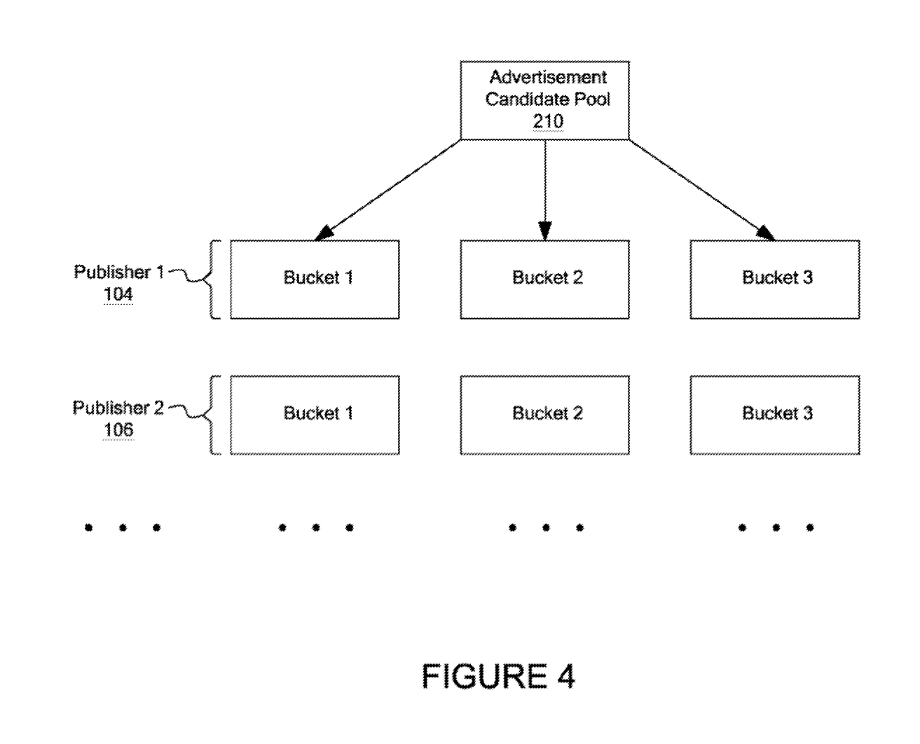

FIG. 4 shows the sorting of advertisements prior to sending to publishers according to one embodiment. The final ads in candidate pool 210 (after any use of filtering process 218) are sorted. In particular, layering is applied to the final ads in pool 210. The ads in pool 210 are sorted into different buckets (or layers) for each publisher. For example (Buckets 1, 2, 3 for publisher 104; or Buckets 1, 2, 3 for publisher 106).

Different priority levels are created (corresponding to each bucket) as to which ads should be sent to a publisher before other ads. For example, if it is desired that pay-per-call ads are sent first, then the pay-per-call (PPC) ads in the candidate pool 210 would be sorted into the first bucket (Bucket 1), and all other ads in pool 210 may be sorted into Bucket 2. Bucket 3 may be used for yet further sorting by another type of ad. In one embodiment, this sorting into buckets will always take precedence over any other rules when selecting ads to send in response to an ad request.

Now, within a particular bucket (e.g., Bucket 1), an intermediate sorting algorithm may be applied to further select a set of advertisements. The algorithm may be, for example, a weighted ad rotation algorithm (discussed in more detail below), or the assigning of tiers and points to the ads in candidate pool 210. Other sorting criteria may include sorting by yield or based on predictions of revenue for a particular advertisement.

Then, ads are selected primarily from the highest priority bucket (obtained from the intermediate sorting above) and used in a priority order. As one example, if three ads are needed for an ad request, and there are two buckets from the sorting above, then two ads may be taken from the first bucket and one ad from the second bucket in order to fulfill the ad request. The one ad from the second bucket would be based on the intermediate sorting logic being applied in that bucket (note that the intermediate sorting logic may be different for each bucket).

After the final ads for delivery are selected per the above approach, then a final sort may be done based on the particular business requirements of the publisher. These requirements may relate to any one of several sorting mechanisms. For a given publisher, the ads from a bucket may merely be randomized, or ads may be sorted by tiers and points (e.g., a point score based on certain business factors such as product features purchased) for contractual reasons, or there may be some other final sort order imposed on the set of advertisements sent to the publisher. In some embodiments, this final sorting may also include sorting by distance of a service (e.g., a restaurant) from a user's current location, or by spending data (e.g., higher spending by a particular publisher, thus providing higher revenues), or other factors such as conversion probability.

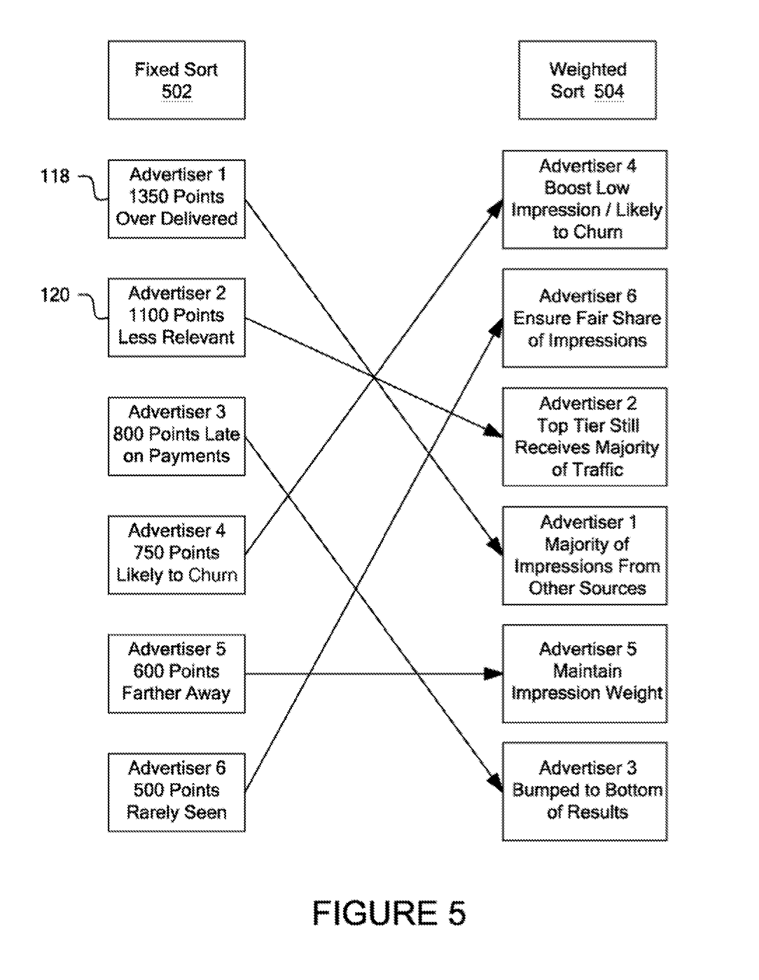

FIG. 5 shows an example of weighted advertisement rotation according to one embodiment, which may be applied to advertisements in a given bucket (e.g., Bucket 1) as described above. A fixed sort 502 and a weighted sort 504 are illustrated—each sort may correspond to ads in a bucket from the sorting discussed above. In fixed sort 502, advertisers 118 and 120 are sorted based on a points score. In weighted sort 504 a weighted advertisement rotation is used that assigns weights to the ads based on relative spending by each advertiser, and rotates ad impressions based on that assigned weight (i.e., ads with higher weights receive more impressions). In one embodiment, ads that receive more (or less) total traffic relative to their assigned weights are sent to publishers in a manner so that they are given less (or more) impressions to users.

In one embodiment, the weights are based upon points, and the churn propensity for a given advertiser and the total click volume (across all traffic sources) can be used to vary the assigned weights up or down. Platform 102 may also segment advertising traffic by algorithm and/or by publisher to test the impact on traffic distribution curves across different configurations.

In another embodiment, ads from candidate pool 210 are sorted into different buckets. Based upon the spend of an ad and other factors, the ads are all weighted and then randomly picked from a bucket based upon these weights. For example, a given bucket may include both pay-per-call and subscription ads. Further, this approach can be turned on or off for each publisher.

In one embodiment, for fixed sort 502 each advertiser has a number of points based on the amount it is paying for its advertisements. For weighted sort 504 the order of the ads is shifted around for various reasons, as discussed below. Here, advertiser 4 is placed in the top slot for this particular search request. Advertiser 1 has already been delivered all of the impressions that were promised, so a lower ordering is used for this ad request.

In one embodiment, advertising platform 102 handles publisher and ad specific rules without requiring code changes by use of a configuration mechanism. At the configuration level rules may be defined on platform 102 for each publisher, for example, using JavaScript object notation (JSON). Some publishers may always place pay-per-call ads first because these achieve the best monetization. Other publishers may place subscription or other ads into the ad rotation so that there is rotation between two types of ads. Platform 102 lets each publisher control whether certain types of ads are increased in priority over other types of ads. For example, ads from competitors may be placed fairly low into the ad mix (e.g., by putting these ads into a lower priority bucket, or mixing the ads in a bucket in with a lower weight). This may be handled through this configuration mechanism. In some embodiments, a publisher may only prefer ads which have phone numbers, or physical addresses, as the publisher may believe that these types of ads create more value for users visiting its website.

In various embodiments, the advertising platform 102 can maintain budget information for individual advertisers. In one embodiment, budget information comprises information that quantifies the value that advertisers have received from the advertising platform, including clicks, impressions or pay-per-performance criteria such as calls or sales. In one embodiment, budget information additionally comprises performance targets for advertisers, and can additionally comprise an estimate as to whether an advertiser is over budget, which is to say, the value the advertiser has received from the advertising platform 102 exceeds performance targets.

In one embodiment, the advertising platform 102 automatically serves traffic for listings for advertisers that are over budget to subscription listings for advertisers which are more in need of value (e.g. below budget). Alternatively, or additionally, in other embodiments, the advertising platform 102 can automatically serve such traffic to the highest yielding performance advertisements. In one embodiment, the advertising platform 102 automatically selects the highest yielding performance advertisements using a basic yield optimization algorithm.

In one embodiment, the advertising platform 102 determines budget information, at least in part, using data from the historical performance database. In one embodiment, the advertising platform 102 stores budget information on the advertisement databases 110, 112 in association with the advertisements and/or advertisers to which they relate.

In one embodiment, the advertising platform 102 determines the value that individual advertisers have received from the platform based on impressions and clicks generated for each advertiser and obtained from multiple sources (e.g. advertiser owned and operated sites, data feed partners, and the platform). In one embodiment, the advertising platform 102 additionally or alternatively determines value provided to advertisers based on calls, sales or other pay-per-performance criteria.

In one embodiment, the advertising platform 102 analyses performance data for advertisers on a regular basis (e.g. daily). In one embodiment, the advertising platform 102 runs multiple models against input data using various times windows (monthly, quarterly, annually), and the output classifies advertisers into categories which can be used by the advertising platform to impact ad delivery.

In one embodiment, one such budgeting model utilizes a performance metric based on impressions and clicks for all subscription listings for an advertiser. For example:

Performance=(Impressions*Impression Weight)+Clicks
where Impressions is the number of impressions for all listing for an advertiser for a time period,
Impression Weight is the relative value of impressions to clicks for the advertiser, and
Clicks is the number of clicks for all listings for an advertiser for the time period

In one embodiment, the advertising platform 102 stores impression weights for individual advertisers on one or database comprising configuration options for advertisers. The advertising platform can additionally provide a user interface that permits the impression weights for individual advertisers to be set and altered on-demand.

In one embodiment, the advertising platform 102 compares the performance metric for each advertiser to a targeted performance to determine if the advertiser is over budget. One method of determining a targeted performance for an advertiser utilizes marketing weights assigned to individual listings. The marketing weight for an individual advertisement reflects the relative value the advertisement has for an advertiser: clicks and impressions for higher rated advertisements are more valuable.

In one embodiment, the advertising platform 102 assigns marketing weights to advertisements based on a marketing tier to which the advertisement is assigned. For example, in one embodiment, the advertising platform 102 supports at least six marketing tiers with differing weights as follows:

| Tier | Weight |
|---|---|
| 1 | 5.5 |
| 2 | 4.5 |
| 3 | 3.4 |
| 4 | 2.3 |
| 5 | 1.6 |
| 6 | 1.0 |

In one embodiment, the advertising platform 102 stores the tier and/or the marketing weight assigned to individual advertisements on the advertising databases 110, 116 where data relating to such advertisements is stored. The advertising platform can additionally provide a user interface that permits the marketing tiers and/or weights for individual advertisements to be set and altered on-demand. In one embodiment, the marketing tier to which advertisements are assigned is specified by the advertiser and may be subject to varying subscription costs.

In one embodiment, the advertising platform 102 calculates a targeted performance for an advertiser using marketing weights as follows:

Target=Base Goal*Advertiser Weight
where Base Goal is a targeted clicks per day for a single listing type (e.g. a Tier 6 listing), and
Advertiser Weight is the sum of the marketing weights for all the individual listings of an advertiser.

In one embodiment, if there are multiple listings within a category, for example, a demographic category, the advertising platform 102 only use the highest weight within the category to contribute to the advertiser weight. For example, if an advertiser has a Tier 2 listing in a first category, and a Tier 3 listing in a second category, the advertiser weight would be 4.5+1.6=6.1.

In one embodiment, if an advertiser's measured value exceeds their target value, the advertising platform 102 categorizes that advertiser as “over budget” or “satisfied”.

In one embodiment, the advertising platform 102 stores the targeted clicks assigned to individual advertisements on the advertising databases 110, 116 where data relating to such advertisements is stored. The advertising platform can additionally provide a user interface that permits the targeted clicks for individual advertisements to be set and altered on-demand. In one embodiment, the targeted clicks for individual advertisements is specified by the advertiser. In one embodiment, the targeted clicks for individual advertisements are determined by the marketing tier to which the advertisements are assigned. In one embodiment, the targeted clicks for individual advertisements are specified by a service provider that provides the advertising platform 102.

In one embodiment, another budgeting model is based on a set of growth metrics. In one embodiment, such growth metrics are based on the advertiser performance metric described above, where

Performance=(Impressions*Impression Weight)+Clicks
where Impressions is the number of impressions for all listing for an advertiser for a time period,
Impression Weight is the relative value of impressions to clicks for the advertiser, and
Clicks is the number of clicks for all listings for an advertiser for the time period

In one embodiment, the advertising platform 102 uses the advertiser performance metric to track at least four measurements.
1. Performance in the most recent 28 days (based on available data).
2. Performance in the 28 days prior to 1.
3. Daily performance in the thee full months prior to the last 28 days.
4. Daily performance for the month one year before the previous 28 days

In one embodiment, the advertising platform 102 maintains per advertiser performance on a daily basis for a fixed period, for example, 60 days. In one embodiment, beyond such fixed period, the advertising platform 102 rolls up the performance data on a monthly basis. Where such roll up affects performance calculations as in, for example, measurements 3 and 4 above, the advertising platform 102 can approximate the data for the exact time period (i.e. the time period will be shifted slightly to line up with cached data).

In one embodiment, the advertising platform 102 uses measurements (1.) to (4.) above to calculate at least three growth metrics as follows:
Monthly growth (performance this month over the previous month)
Quarterly growth (performance this month over the corresponding month in the previous quarter)
Annual growth (performance this month over the same month last year; in one embodiment, annual growth is a 12 month accumulation of the monthly growth metric)

In one embodiment, on a periodic basis, for example, daily, the advertising platform 102 flags each of these metrics for individual advertisers as “pass” or “fail”. For example, if the monthly growth goal is 1% and the previous 28 days had value of 100 clicks, then the target would be 101. If the monthly performance exceeds that number, the monthly growth metric is flagged as “pass”, otherwise the monthly growth metric is flagged as “fail”. If the advertiser has not been active long enough to measure a value, the monthly growth metric is flagged as “fail”.

In one embodiment, the advertising platform 102 stores growth metrics and growth targets for each of the above performance metrics for each advertiser on the advertisement databases 110, 112 in association with the advertisements and/or advertisers to which they relate. The advertising platform can additionally provide a user interface that permits the targeted growth for individual advertisers to be set and altered on-demand. In one embodiment, the targeted clicks for individual advertisements is specified by the advertiser. In one embodiment, the targeted growth for individual advertisers is specified by a service provider that provides the advertising platform 102.

In one embodiment, the advertising platform 102 assigns a budget weighting value for each advertiser based on the performance and growth metrics for each advertiser. In various embodiments, a budget weight value is generally a number or value that represents that is used to influence processing of data, such as, for example, the selection or sorting of data. In one embodiment, the budget weighting value takes a value between 0.0 and 1.0, where 0.0 is a minimum budget weighting value and 1.0 is a maximum budget weighting value. As the budget weighting value for an advertiser decreases, advertisements for the advertiser receive a lower priority for selection and/or sorting within a bucket, as described in detail below.

In one embodiment, the advertising platform 102 decreases the budget weighting value for an advertiser when the performance metric for the advertiser is “satisfied”. In one embodiment, the advertising platform 102 decreases the budget weighting value for an advertiser when one or more of the growth metrics are flagged as “pass”. In one embodiment, advertisers whose performance metric is not “satisfied”, and for which all growth metrics are flagged as “fail” are assigned a maximum budget weight factor, for example, 1.0. In one embodiment, advertisers whose performance metric is “satisfied”, and for which all growth metrics are flagged as “pass” are assigned a minimum budget weighting value, for example, 0.0.

In one embodiment, if the budget weighting value is not 0.0, the advertising platform 102 uses the budget weighting value as a modifier to weights when applying weighted rotation to advertisements. In one embodiment, if the budget weighting value is for an advertiser 0.0, the traffic becomes backfill within the bucket (or layers) into which the advertisements are sorted (e.g. such ads automatically get the last place in the bucket in which they sorted). In one embodiment, if the budget weighting value is for an advertiser 0.0, the advertising platform 102 removes advertisements for the advertiser from the candidate pool.

In one embodiment, the advertising platform 102 permits the entry of manual overrides for advertisers such that performance and growth metrics for such advertisers do not affect the selection or sorting of advertisements. In one such embodiment, the advertising platform 102 continues to track performance and growth metrics for such advertisers.

In one embodiment, if an advertiser is over three months old, the advertiser becomes eligible for “pausing”. In one embodiment, an advertiser is paused by setting the budget weighting value for the advertiser to 0.0, causing advertisements for such advertisers to be excluded from the candidate pool or become backfill in the bucket into which they are sorted. In one embodiment, the advertising platform pauses an advertiser is paused when the advertiser is “satisfied” based on the performance metric and at least two of the three growth metrics are flagged as “pass”. In this case, the advertiser weight is set to 0.0, and they will move to the backfill section of their relevancy rank.

In the embodiments described above, advertisers that have been active less than three months automatically fail at least two of the growth tests, which tends to give such advertisers an advantage over legacy advertisers. To offset this effect, in one embodiment, the advertising platform 102 automatically sets the budget weighting value for advertisers that have been active less than three months to a default new account budget weighting value. In one embodiment, the default new account budget weighting value is set at a level where advertisements for such advertisers tend to be ranked lower than legacy advertisers, but do not become backfill in the buckets into which they are sorted (e.g. a budget weighting value of 0.5). In one such embodiment all other advertisers which are not paused are maintained at a default weight of 1.0.

It should be understood that the techniques described above for using performance and growth metrics to influence the selection and ordering of advertisements for transmission to publishers can be generally applied to any type of data where performance can be tracked. For example, performance and growth metrics could be tracked for various types of online coupons, phone calls relating to pay-per-call advertisements, checkins and/or store purchases. Such performance and growth metrics could then be used to influence, for example, the presentation of such online coupons or pay-per-call advertisements.

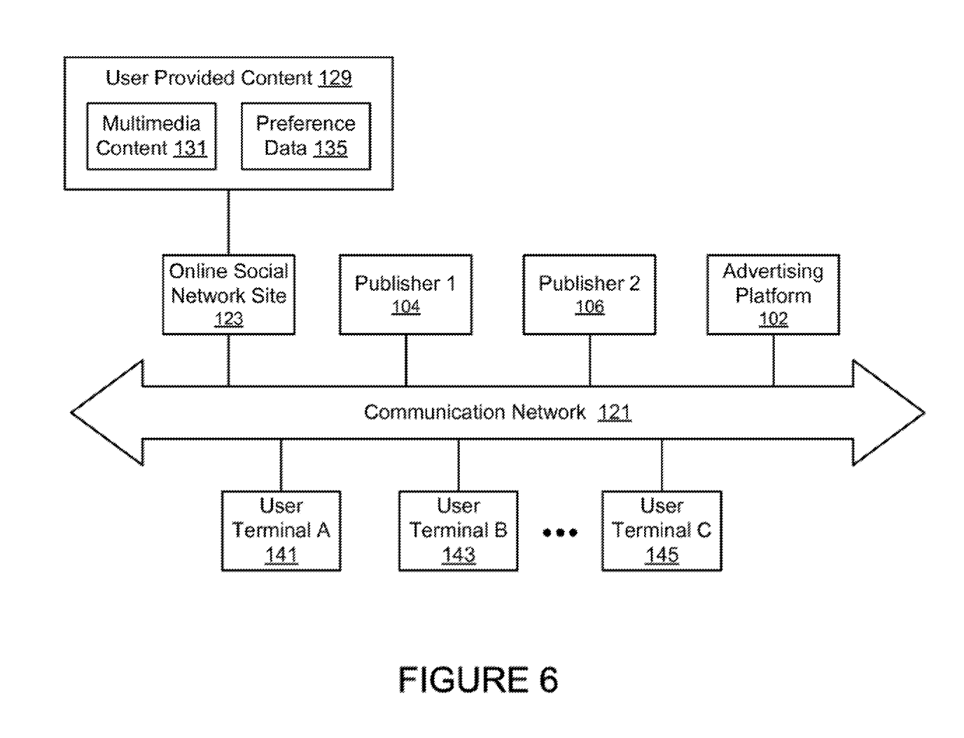

FIG. 6 shows a system for communications between user terminals, publishers, and the advertising platform 102 according to one embodiment. In FIG. 6, the user terminals (e.g., 141, 143, . . . , 145) are used to access websites of publishers 104 and 106 over a communication network 121 (e.g., the Internet, a local area network, or a wide area network).

The user terminals may also access other websites, for example an online social network site 123 over communication network 121. The user terminals may access yet other websites (not shown). Publishers 104 and/or 106 also communicate with advertising platform 102 over communication network 121. Advertising platform 102 may also communicate with ad databases 110, 112 over communication network 121. Advertising platform 102 sends advertisements to publishers 104, 106, which send a web page to a user terminal for display of the web page to the user, which includes one or more of these advertisements as determined by the publisher when rendering the web page for sending to the user terminal.

The publishers 104 and 106 and/or online social network site 123 may include one or more web servers (or other types of data communication servers) to communicate with the user terminals (e.g., 141, 143, . . . , 145). The online social network site 123 is connected to a data storage facility to store user provided content 129, such as multimedia content 131, preference data 135, etc.

In FIG. 6, the users may use the terminals (e.g., 141, 143, . . . , 145) to make implicit or explicit search or other requests for services. The user selections can be used as implicit recommendations. The publishers 104 or 106 may send information related to these requests to advertising platform 102. A search request may be seeking information regarding services at a certain location.

In one embodiment, the user terminal (e.g., 141, 143, . . . , 145) can also be used to submit multimedia content (e.g., 131). For example, in one embodiment, the user terminal includes a digital still picture camera, or a digital video camera. At a transition point, the user terminal can be used to create multimedia content for sharing with friends in the online social network 123.

Alternatively, the multimedia content can be created using a separate device and loaded into the online social network 123 using the user terminal (e.g., 141, 143, . . . , 145). The users may manually tag the multimedia content with personal data or data related to the user's current experience at a location.

Although FIG. 6 illustrates an example system implemented in client server architecture, embodiments of the disclosure can be implemented in various alternative architectures. For example, the publishers 104 and 106, and online social network 123 can be implemented via a peer to peer network of user terminals, where the multimedia content and other data are shared via peer to peer communication connections.

In some embodiments, a combination of client server architecture and peer to peer architecture can be used, in which one or more centralized server may be used to provide some of the information and/or services and the peer to peer network is used to provide other information and/or services. Thus, embodiments of the disclosure are not limited to a particular architecture.

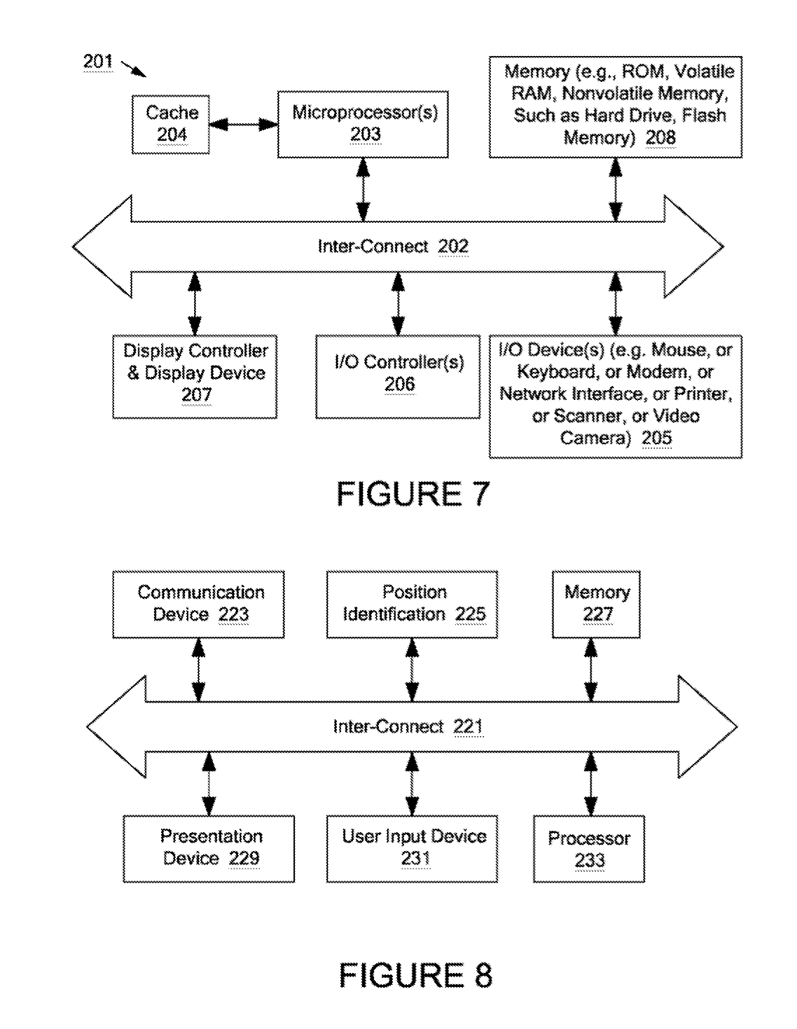

FIG. 7 shows a block diagram of a data processing system which can be used in various embodiments. While FIG. 7 illustrates various components of a computer system, it is not intended to represent any particular architecture or manner of interconnecting the components. Other systems that have fewer or more components may also be used.

In FIG. 7, the system 201 includes an inter-connect 202 (e.g., bus and system core logic), which interconnects a microprocessor(s) 203 and memory 208. The microprocessor 203 is coupled to cache memory 204 in the example of FIG. 7.

The inter-connect 202 interconnects the microprocessor(s) 203 and the memory 208 together and also interconnects them to a display controller and display device 207 and to peripheral devices such as input/output (I/O) devices 205 through an input/output controller(s) 206. Typical I/O devices include mice, keyboards, modems, network interfaces, printers, scanners, video cameras and other devices which are well known in the art.

The inter-connect 202 may include one or more buses connected to one another through various bridges, controllers and/or adapters. In one embodiment the I/O controller 206 includes a USB (Universal Serial Bus) adapter for controlling USB peripherals, and/or an IEEE-1394 bus adapter for controlling IEEE-1394 peripherals.

The memory 208 may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 7 is used to implement advertising platform 102, servers for publishers 104, 106, online social network site 123, and/or other servers, such as a server to support various advertisement databases.

In one embodiment, a data processing system as illustrated in FIG. 7 is used to implement a user terminal. A user terminal may be in the form of a personal digital assistant (PDA), a cellular phone, a notebook computer or a personal desktop computer.

In some embodiments, one or more servers of the system can be replaced with the service of a peer to peer network of a plurality of data processing systems, or a network of distributed computing systems. The peer to peer network, or a distributed computing system, can be collectively viewed as a server data processing system.

Embodiments of the disclosure can be implemented via the microprocessor(s) 203 and/or the memory 208. For example, the functionalities described can be partially implemented via hardware logic in the microprocessor(s) 203 and partially using the instructions stored in the memory 208. Some embodiments are implemented using the microprocessor(s) 203 without additional instructions stored in the memory 208. Some embodiments are implemented using the instructions stored in the memory 208 for execution by one or more general purpose microprocessor(s) 203. Thus, the disclosure is not limited to a specific configuration of hardware and/or software.

FIG. 8 shows a block diagram of a user terminal or device according to one embodiment. In FIG. 8, the user device includes an inter-connect 221 connecting the presentation device 229, user input device 231, a processor 233, a memory 227, a position identification unit 225 and a communication device 223.

In FIG. 8, the position identification unit 225 is used to identify a geographic location of the user (e.g., a location may be provided to publisher 104 from user terminal 141 when a user makes a search request). The position identification unit 225 may include a satellite positioning system receiver, such as a Global Positioning System (GPS) receiver, to automatically identify the current position of the user device. Alternatively, an interactive map can be displayed to the user; and the user can manually select a location from the displayed map.

In FIG. 8, the communication device 223 is configured to communicate with publisher 104 or 106, or an online social network 123 to provide user data content tagged with other data provided by the user or automatically provided by the user terminal. The user input device 231 may include a text input device, a still image camera, a video camera, and/or a sound recorder, etc.

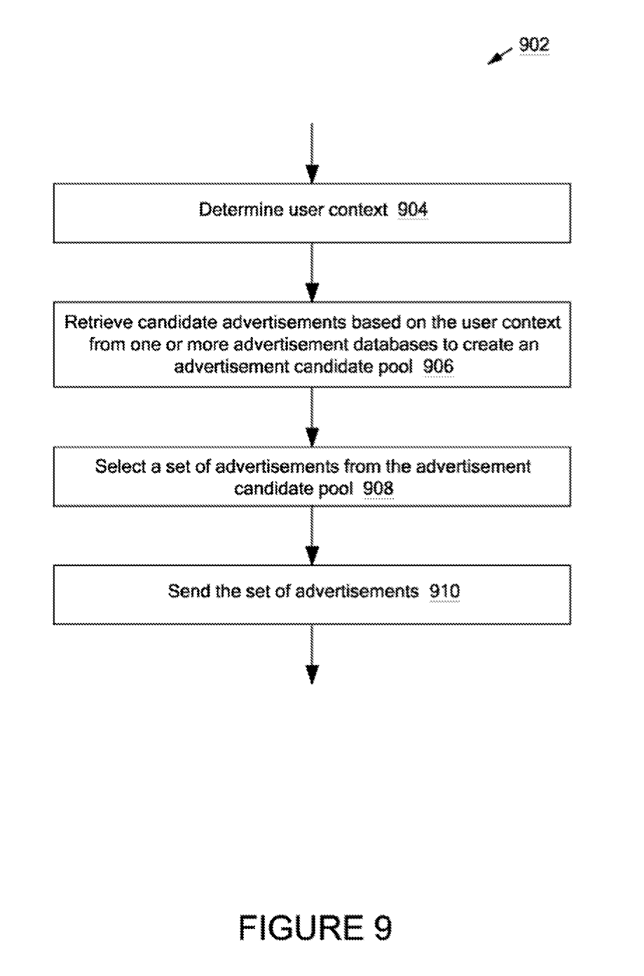

FIG. 9 shows a method 902 to select an advertisement from at least one database using advertising system 102 of FIG. 1 according to one embodiment. In block 904, a user context is determined. In block 906, advertising platform 102 retrieves candidate advertisements from one ore more advertisement databases to create an advertisement candidate pool. The user context is used in this retrieving.

In block 908, a set of advertisements is selected from the advertisement candidate pool (e.g., the ads are selected in order to reply to an ad request from a publisher prompted by a user search request). In block 910, the set of advertisements is sent from advertising platform 102 to publisher 104 or 106.

In one embodiment, in addition to selecting ads based on user context, the ad selection may be further based on user location. As an example of geographic relevance, consideration is given to how ads will perform for a given ad request in part based on the location of the user. For example, a distinction is made between direct and indirect matches so that if a user is searching for pizza in Glendale, then an ad for a pizza place in Glendale will perform better than an ad for a pizza place in a nearby city. So, a direct match (e.g., either a city name or a zip code) is given a higher priority over factors that are only an indirect match (this is direct and indirect layering).

In one embodiment, ads are generally selected so that the advertiser's location is closer to what the user is searching for. Advertisers only pay for presence when using subscription ad products, and not for specific impressions or specific value of any kind. So, the advertising space is expanded somewhat in order to distribute the ad traffic better for these particular advertisers. Although a pure distance sort might be best for conversions, it is not the most ideal for distributing advertising value.

One specific example of preparing a reply to an advertisement request from a publisher is now described. In this example, there are two types of ads (subscription and pay-per-call). A search request is received from a publisher, and the request includes some context about the ad that the publisher desires to show. Here, a user has made a request related to a terminal location using keywords such as “pizza”, “restaurant”, and “Glendale”. These keywords are next turned into candidate ads as discussed above.

In this example, platform 102 implements processes related to its subscription ad listings. These keywords are run through a categorization process in which the word “pizza” is mapped into a category of “pizza restaurants”, and may be further mapped to secondary categories of “Italian restaurants”, etc. The location key word is mapped into a geography category.

Some ads are sold for limited service areas, and some ads are sold nationally. These categories and locations are used to do a reverse index search in order to retrieve ads that match the categories and locations. So, all ads under the category “pizza restaurants” becomes the initial candidate pool (i.e., this provides ad candidates for subscription ads). For pay-per-call ads, the keywords and the location are used to select pay-per-call ads (e.g., within a predetermined diameter or distance of a user location, or in a zip code associated with a particular business location). For example, further candidate ads are retrieved for an advertiser wanting customer calls within five miles of its business, and where the customer has used the word “pizza” in its search. These ads are added to the candidate pool.

In this example, a normalization process is applied to put all of the ads in the candidate pool on an equal footing so that any of the sorting/selection algorithms can work on any of the ad types in the ad candidate pool. Some de-duping may be applied to filter the results and other filtering performed as discussed above. For example, filtering may be done based on rules in which a publishers states it does not want any ads of a mature/adult nature, or it only wants ads with phone numbers because the publisher's business relies on mobile phone communications with customers. After filtering, a final ad candidate pool is obtained. The ad selection processes and algorithms described above are then applied to select a final set of advertisements for sending in reply to an advertisement request.

Prior to sending the final ads, the ad may go through a final step of preparing them for display. For example, for pay-per-call ads, the ads may go to another system in platform 102 that generates a call-tracking number that is appropriate for the publisher requesting the ads.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using an Application-Specific Integrated Circuit (ASIC) or a Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

### Advertising Platform Example

An example in one specific embodiment of advertising platform 102 is now discussed below. This example describes certain high-level aspects of the logic and flow used for ad delivery. Platform 102 may implement its logic in Java

### Initial Inputs

This section describes ways that advertising platform 102 may be called. This corresponds generally to a publisher passing a search term and search location in to platform 102.

After resolving parameters associated with these inputs, the following are obtained:
Publisher partner code
User search term
User search location
Search type: Name, Category, or Term. A “name” search term is interpreted as a business name. A “category” search term is interpreted as a category or keyword.

### Retrieving Candidate Ads

This section describes the initial step of collecting candidate ads from different ad sources. In this case, this includes details on how to take the search term and search location, and to get a list of the ads which are eligible for display. There are two sources (subscription and pay-per-call) described in more detail in each of the sections below. For a given publisher/ad request, one or both of the sources will be called to find candidate ads. If no candidate ads are returned, then no ads are sent to the publisher.

The first step is to find a set of candidate ads, which can be selected from. Based on the user search term and geography, candidates can be identified. There are two paths, which may be run in parallel: retrieving subscription ads and PPC ads. The two paths are described below. Note that depending on the publisher configuration, only one of the paths may be used.

### Retrieving Subscription Ads

This section describes how to determine eligible subscription ads (listings).

First, an internal system is used to resolve the plain text search term and location into machine-usable information. Locations will be mapped into either lat/lon positions, or other common things like city and state, neighborhoods, or points of interest (e.g., major airports or landmarks).

The search term will be matched against both business names and categories, with the most likely interpretation being chosen. After analyzing the search term, it will be classified as either a category search, with a list of associated categories, or as a name search, with a list of associated businesses, or as an unknown term (in which case no ads will be returned).

Based on the determined geographies and categories, a list of relevant ads are retrieved from a high performance index which has been prepared to make such retrieval highly efficient.

### Retrieving PPC Ads

This works in a similar fashion to the subscription ads, but using a system which has been tuned towards the pay-per-call model. For example, this will enforce hours of operation, so ads are not shown for businesses where the phones are not currently being manned, as calls to these numbers will generate no revenue. Furthermore, there may be budget issues where an advertiser only wants to spend a fixed amount of money, so their listings would not be available after they received a sufficient amount of calls.

### Filtering Ads

Once the list of eligible ads is obtained from each source, there is extra business logic that may depend on the specific publisher that is requesting the ads. These filtering rules narrow the set of listings to the final candidate pool.

Filtering may occur during the retrieval step, if the filter is specific to subscription or PPC listings, or may occur after the ads have been combined into a single list. Platform 102 may support the following filtering options:
address required will filter out ads with no visible address.
phone_required will filter out ads with no visible phone number.
business_names will filter out ads with matching business names (this might be used to blacklist competitors from a specific publisher's sites).
alternatively or additionally, business_names could filter out ads without matching business names (e.g. function as a whitelist).
strict_geo_matching will filter out SUB ads if there was an explicit city or zip in the search and the ad does not contain the same city or zip,

### Selecting Ads

This section describes the step where the ads are put in the candidate pool, and chooses the ads that will be provided for this specific ad call (i.e., ad request). First, normalization is done to make sure that the business rules can be run regardless of the source of the ads. Next, bucketing, scoring, and sorting logic is used to obtain the final set of ads.

The first step in ad selection is normalizing the subscription and PPC ads. This includes analyzing PPC performance and bid prices, and deciding how these should be handled relative to subscription products.

Additional Filtering: Ad Selection may perform additional filtering steps:
De-duping. If any ads share the same business identifier, then only one of each matching listing will be kept. The one kept may be chosen randomly, to distribute traffic across the listings.
Backfill logic. For name searches, depending on the name_searches configuration option, name matches or category matches may be supported.

After normalization, the ad selection process is run.

The final set of selected ads will be annotated for tracking and logging purposes. By recording information about how decisions were made, one can do bucket tests to see how different algorithms are performing, or measure nuances in how the system is behaving.

### Formatting Ads

This is the final detail after the ads are selected that will be shown—anything necessary to show the actual listing is retrieved to assemble the final ads. This includes all the metadata (e.g., tag lines, image URLs, etc.) as well as allocating call-tracking numbers.

Once the final set of ads is obtained for display, additional information is retrieved to include in the reply to the ad request. The method to get this information is different for subscription and PPC listings—platform 102 may perform these calls in parallel.

### Logging

This is how data is logged about what happened with respect to the ads—it becomes the core of the feedback loop where platform 102 can learn and improve over time (as well as use for basic details like reporting results to advertisers and paying publishers). [00145] First, all requests and information about those requests gets logged by writing a record describing the request to disk. This record includes a unique identifier (UUID) which will be used to join subsequent user activity to the initial request. For a system more similar to being real-time, these records may also broadcast events over UDP which can be monitored by other systems. The request record will be associated with a list of all the impressions which are being shown: either subscription or PPC.

Next, all user activity which can be tracked should also record that information. Clicks will generally go through a special “click wrapper”, which records the information about the click, and forwards the user to the destination URL. Information about each click will be associated with the original request via the UUID which was created to identify the request.

Information about phone calls is tracked via CTNs (call tracking numbers). This can be used to measure the performance of the system as a whole.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

I claim:

1. A method, comprising:
logging, via a server system, performance data regarding user interactions with a plurality of advertisements and adding the performance data to an historical performance database , where each of the plurality of advertisements relating to a respective one of a plurality of advertisers, and where the performance data stored on the historical performance database includes annotations to each advertisement and tracking each advertisement using said annotation and storing said tracking data to the historical performance database;
determining, by advertisement platform processing at the server system, a respective performance metric for each advertiser of the plurality of advertisers based at least in part on the performance data and tracking data stored in the historical performance database for the respective advertisements relating to the respective advertiser over a past time period, where the tracking data includes one or more of impressions and clicks;
assigning, by a budgeting model processing at the server system, a respective budget weighting value, which corresponds to a modifier to modify one or more weights of advertisements, to each advertiser of the plurality of advertisers using the respective performance metric for the respective advertiser, wherein the respective budget weight value assigned to the respective advertiser is based at least in part on comparing the respective performance metric corresponding to the past time period for the respective advertiser to a targeted performance for the respective advertiser where the targeted performance is calculated by the advertisement platform calculating at the server system and said calculation is based on one or more of targeted daily clicks and an assigned marketing weight;
processing a call received by the server system via an application programming interface from a server of a publisher, the call corresponding to an advertisement request;
retrieving candidate advertisements from at least one advertisement database of the server system to create an advertisement candidate pool, the candidate advertisements comprising a first advertisement corresponding to a first advertiser of the plurality of advertisers and a second advertisement corresponding to a second advertiser of the plurality of advertisers;
based at least in part on comparing a first performance metric for the first advertiser to a first target performance, storing by the server system a first budget weighting value and an association of the first budget weighting value with the first advertiser and the first advertisement corresponding to the first advertiser.
based at least in part on comparing a second performance metric for the second advertiser to a second target performance, storing by the server system a second budget weighting value and an association of the second budget weighting value with the second advertiser and the second advertisement corresponding to the second advertiser;
assigning, by the server system, respective weights to the candidate advertisements according to one or more factors so that the candidate advertisements are ranked to correspond to a first ranked order;
modifying, by the server system, the respective weights of at least some of the candidate advertisements, the modifying the respective weights comprising: modifying a first weight of the first advertisement corresponding to the first advertiser using the first budget weighting value to result in at least a first modified weight, and modifying a second weight of the second advertisement corresponding to the second advertiser using the second budget weighting value to result in at least a second modified weight;
ranking, by a ranking function algorithm processing at the server system, the candidate advertisements such that the candidate advertisements are in a second ranked order based at least in part on the first modified weight based on the first budget weighting value and the second modified weight based on the second budget weighting value, the second ranked order being different from the first ranked order;
selecting one or more of the candidate advertisements according to the second ranked order for presentation to a user to via a media channel; and
transmitting the selected one or more of the candidate advertisements in reply to the call from the server of the publisher.

2. The method of claim 1 wherein:
the performance data comprises clicks and impressions for each of the plurality of advertisements.

3. The method of claim 2 wherein:
the performance metric is determined for each of the plurality of advertisers using an equation of the form:
performance metric=(impressions*impression weight)+clicks
where impressions is a number of impressions for all advertisements relating to the respective advertiser for a first time period,
impression weight is a relative value of impressions to clicks for the respective advertiser; and
clicks is a number of clicks for all advertisements relating to the respective advertiser for the first time period

4. The method of claim 3 wherein:
the budget weighting value is assigned to each of the plurality of advertisers using a method comprising:
assigning a first budget weighting value to the respective advertiser only if the performance metric for the respective advertiser exceeds a targeted performance for the respective advertiser; and
assigning a second budget weighting value to the respective advertiser only if the performance metric for the respective advertiser does not exceed the targeted performance for the respective advertiser,
wherein the first budget weighting value is lower than the second budget weighting value.

5. The method of claim 4 wherein:
the targeted performance for each of the plurality of advertisers is determined using an equation of the form:
targeted performance=base goal*advertiser weight
where base goal is a targeted clicks per day for a single listing type, and
advertiser weight is a sum of marketing weights assigned to each of the advertisements for the respective advertiser.

6. The method of claim 3, additionally comprising:
determining a growth metric for each of one or more of the plurality of advertisers using the performance data for the respective advertisements relating to the respective advertiser,
wherein the budget weighting value is assigned to each of the one or more of the plurality of advertisers using the performance metric and the growth metric for the respective advertiser.

7. The method of claim 6 wherein:
the growth metric for each of the one or more of the plurality of advertisers is determined by comparing the performance metric for the respective advertiser to an historical performance metric for the respective advertiser for a second time period occurring before the first time period.

8. The method of claim 7 wherein:
the budget weighting value is assigned to each of the one or more of the plurality of advertisers using a method comprising:
assigning a first budget weighting value to the respective advertiser only if the performance metric for the respective advertiser exceeds a targeted performance for the respective advertiser and the growth metric for the respective advertiser exceeds a targeted growth for the respective advertiser; and
assigning a second budget weighting value to the respective advertiser only if the performance metric for the respective advertiser does not exceed a targeted performance for the respective advertiser and the growth metric for the respective advertiser does not exceed a targeted growth for the respective advertiser;
assigning a third budget weighting value to the respective advertiser only if the performance metric for the respective advertiser exceeds a targeted performance for the respective advertiser and the growth metric for the respective advertiser does not exceed a targeted growth for the respective advertiser;
assigning a fourth budget weighting value to the respective advertiser only if the performance metric for the respective advertiser does not exceed a targeted performance for the respective advertiser and the growth metric for the respective advertiser exceeds a targeted growth for the respective advertiser; and
wherein the first budget weighting value is a minimum budget weighting value and the second budget weighting value is a maximum budget weighting value.

9. The method of claim 6, additionally comprising:
determining that there is insufficient performance data to calculate a growth metric for at least one of the plurality of advertisers; and
assigning a default budget weighting value to the at least one of the plurality of advertisers.

10. The method of claim 1, additionally comprising:
receiving an override budget weighting value for one of the plurality of advertisers, wherein the override budget weighting value overrides the budget weighting value for the one of the plurality of advertisers.

11. The method of claim 1, additionally comprising:
determining that at least one of the candidate advertisements relates to an advertiser whose respective budget weighting value falls below a minimum budget weighting value,
wherein the at least one of the candidate advertisements is deleted from the advertisement candidate pool.

12. The method of claim 1, additionally comprising: determining a user context, wherein the retrieving is based on the user context.

13. The method of claim 12, wherein:
the determining the user context comprises receiving a first advertisement request comprising user search data corresponding to a search request of a user, the user search data including a search term;
the retrieving is based on the search term; and
the sending the set of advertisements is in reply to the first advertisement request.

14. The method of claim 13, wherein the user search data further includes a search location, and the retrieving is further based on the search location.

15. The method of claim 1, wherein each of the plurality advertisers is associated with at least one of the plurality of advertisements.

16. The method of claim 1 wherein:
the performance data comprises calls.

17. A non-transitory computer-readable storage medium for tangibly storing thereon computer readable instructions, the instructions causing a server system to perform a method, the method comprising:
logging performance data regarding user interactions with a plurality of advertisements and adding the performance data to an historical performance database, where each of the plurality of advertisements relating to one of a plurality of advertisers, and where the performance data stored on the historical performance database includes annotations to each advertisement and tracking each advertisement using said annotation and storing said tracking data to the historical performance database;
determining, by advertisement platform processing at the server system, a respective performance metric for each advertiser of the plurality of advertisers using the performance data and tracking data stored in the historical performance database for the respective advertisements relating to the respective advertiser over a past time period, where the tracking data includes one or more of impressions and clicks;
determining a respective growth metric for each advertiser of the plurality of advertisers based at least in part on of the performance data for the respective advertisements relating to the respective advertiser over a past time period;
assigning by a budgeting model processing at the server system, a respective budget weighting value, which corresponds to a modifier to modify one or more weights of advertisements, to each advertiser of the plurality of advertisers using the respective performance metric and the growth metric for the respective advertiser, wherein the respective budget weight value assigned to the respective advertiser is based at least in part on comparing the respective performance metric corresponding to the past time period for the respective advertiser to a targeted performance for the respective advertiser, where the targeted performance is calculated by the advertisement platform calculating at the server system and said calculation is based on one or more of targeted daily clicks and an assigned marketing weight;
processing a call received by the server system via an application programming interface from a server of a publisher, the call corresponding to an advertisement request;
retrieving candidate advertisements from at least one advertisement database of the server system to create an advertisement candidate pool, the candidate advertisements comprising a first advertisement corresponding to a first advertiser of the plurality of advertisers and a second advertisement corresponding to a second advertiser of the plurality of advertisers
based at least in part on comparing a first performance metric for the first advertiser to a first target performance, storing a first budget weighting value and an association of the first budget weighting value with the first advertiser and the first advertisement corresponding to the first advertiser;
based at least in part on comparing a second performance metric for the second advertiser to a second target performance, storing a second budget weighting value and an association of the second budget weighting value with the second advertiser and the second advertisement corresponding to the second advertiser.
assigning respective weights to the candidate advertisements according to one or more factors so that the candidate advertisements are ranked to correspond to a first ranked order;
modifying respective weights of at least some of the candidate advertisements, the modifying the respective weights comprising: modifying a first weight of the first advertisement corresponding to the first advertiser using the first budget weighting value to result in at least a first modified weight, and modifying a second weight of the second advertisement corresponding to the second advertiser using the second budget weighting value to result in at least a second modified weight;
ranking , by a ranking function algorithm processing at the server system, the candidate advertisements such that the candidate advertisements are in a second ranked order based at least in part on the first modified weight based on the first budget weighting value and the second modified weight based on the second budget weighting value, the second ranked order being different from the first ranked order;
selecting one or more of the candidate advertisements according to the second ranked order for presentation to a user to via a media channel; and
transmitting the selected one or more of the candidate advertisements in reply to the call from the server of the publisher.

18. A server system, comprising:
memory storing at least one advertisement database;
at least one server coupled to access the memory, the at least one server configured to cause the server system to:
log performance data regarding user interactions with a plurality of advertisements and adding the performance data to an historical performance database , where each of the plurality of advertisements relating to one of a plurality of advertisers, and where the performance data stored on the historical performance database includes annotations to each advertisement and tracking each advertisement using said annotation and storing said tracking data to the historical performance database;
determine, by advertisement platform processing at the server system, a respective performance metric for each advertiser of the plurality of advertisers based at least in part on of the performance data and tracking data stored in the historical performance database for the respective advertisements relating to the respective advertiser over a past time period, where the tracking data includes one or more of impressions and clicks;
determine a respective growth metric for each advertiser of the plurality of advertisers using the performance data for the respective advertisements relating to the respective advertiser,
assign, by a budgeting model processing at the server system, a respective budget weighting value, which corresponds to a modifier to modify one or more weights of advertisements, to each advertiser of the plurality of advertisers using the respective performance metric and the growth metric for the respective advertiser, wherein the respective budget weight value assigned to the respective advertiser is based at least in part on comparing the respective performance metric corresponding to the past time period for the respective advertiser to a targeted performance for the respective advertiser, where the targeted performance is calculated by the advertisement platform calculating at the server system and said calculation is based on one or more of targeted daily clicks and an assigned marketing weight;
process a call received by the server system via an application programming interface from a server of a publisher, the call corresponding to an advertisement request;
retrieve candidate advertisements from at least one advertisement database to create an advertisement candidate pool, the candidate advertisements comprising a first advertisement corresponding to a first advertiser of the plurality of advertisers and a second advertisement corresponding to a second advertiser of the plurality of advertisers based at least in part on comparing a first performance metric for the first advertiser to a first target performance, store a first budget weighting value and an association of the first budget weighting value with the first advertiser and the first advertisement corresponding to the first advertiser.
based at least in part on comparing a second performance metric for the second advertiser to a second target performance, store a second budget weighting value and an association of the second budget weighting value with the second advertiser and the second advertisement corresponding to the second advertiser;
assign respective weights to the candidate advertisements according to one or more factors so that the candidate advertisements are ranked to correspond to a first ranked order;
modify respective weights of at least some of the candidate advertisements, the modifying the respective weights comprising: modifying a first weight of the first advertisement corresponding to the first advertiser using the first budget weighting value to result in at least a first modified weight, and modifying a second weight of the second advertisement corresponding to the second advertiser using the second budget weighting value to result in at least a second modified weight;
rank, by a ranking function algorithm processing at the candidate advertisements such that the candidate advertisements are in a second ranked order based at least in part on the first modified weight based on the first budget weighting value and the second modified weight based on the second budget weighting value, the second ranked order being different from the first ranked order;
select one or more of the candidate advertisements according to the second ranked order for presentation to a user to via a media channel; and
transmit the selected one or more of the candidate advertisements in reply to the call from the server of the publisher.
